(19) United States
(12) Patent Application Publication
(10) Pub. No.: US 2025/0209530 A1
(43) Pub. Date: Jun. 26, 2025

(54) Macro Adaptive Hyper Model for Underwriting

(71) Applicant: PAYPAL, INC., San Jose, CA (US)

(72) Inventors: Satyabrata Mishra, Bengaluru (IN); Gaurav Sagar, Chennai (IN)

(21) Appl. No.: 18/394,936

(22) Filed: Dec. 22, 2023

(51) Int. Cl. G06Q 40/03

(52) U.S. Cl. CPC G06Q 40/03

(57) ABSTRACT

From a plurality of sources, data pertaining to one or more users is accessed. Based on the data, one or more original underwriting model scores are determined for the users. Based on the one or more original underwriting model scores, an initial approval decision is generated for one or more credit applications associated with the one or more users. One or more macro environmental criteria is monitored. Based on the monitoring indicating that the one or more macro environmental criteria has exceeded a specified threshold, the one or more macro environmental criteria and the one or more original underwriting model scores are inputted into a hyper model. Via the hyper model, one or more scaled underwriting model scores are determined for the one or more users. Based on the one or more scaled underwriting model scores, a revised approval decision is generated for one or more credit applications.

### BACKGROUND

### Field of the Invention

The present application generally relates to machine learning. More particularly, the present application involves using improved machine learning modeling techniques to evaluate users.

### Related Art

Over the past several decades, rapid advances in integrated circuit fabrication and wired/wireless telecommunications technologies have brought about the arrival of the information age, where electronic activities and/or online transactions are becoming increasingly more common. Machine learning has been used to predict one or more behavioral characteristics of users in conducting these activities and/or transactions, for example, with respect to a risk of the users defaulting on a loan or a credit line. However, many machine learning models have not sufficiently taken into account of an impact of macro environmental criteria on the behavioral characteristics of the users. Therefore, although existing machine learning models are generally adequate for their intended purposes, they have not been entirely satisfactory in every aspect, which can result in inaccurate predictions that lead to loss, risk, and otherwise making wrong decisions based on the inaccurate predictions. What is needed is an improved machine learning model that can more accurately predict the behavioral characteristics users based on the macro environmental criteria.

### BRIEF DESCRIPTION OF THE FIGURES

FIG. 1 is a block diagram of a networked system according to various aspects of the present disclosure.

FIG. 2 illustrates a simplified block diagram corresponding to a process flow for generating and revising a score based on macro environmental conditions according to embodiments of the present disclosure.

FIG. 3 illustrates a data transformation process according to various aspects of the present disclosure.

FIG. 4 illustrates additional details of a hyper model according to various aspects of the present disclosure.

FIG. 5 illustrates a graph containing original approval decision data and revised approval decision data according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is a flowchart illustrating a method of generating an approval decision based on macro environmental conditions according to various aspects of the present disclosure.

FIG. 9 is an example computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using machine learning models and machine learning (ML) to evaluate the behavioral characteristics of users. In more detail, a user (e.g., a customer) of a digital wallet provider (or another online platform) may apply for a financial products, such as a loan or a credit line (or another type of financial product or a predefined benefit (e.g., a status or a membership)), or the digital wallet provider may proactively determine whether or not to offer a loan or a credit line (or the other types of financial products or status or membership) to the user without the user explicitly requesting them. In order to determine the risks associated with giving the loan or the credit line to the user, the digital wallet provider may utilize a machine learning model to predict certain behavioral characteristics of the user, for example, the likelihood of the user being late or missing loan payments, or defaulting on the loan altogether. The digital wallet provider may then identify users who are less risky and users who are riskier. The digital wallet provider may then offer the credit line to the users who have been identified as being less risky, but decline the offering of the credit line to the users who have been identifies as being riskier.

However, the machine learning models in the above process often do not sufficiently take the macro environmental criteria into account. For example, inflation (as one of the indicators for a macro-economic environment) may have a meaningful impact on the riskiness of a loan or a line of credit. When inflation is within an acceptably low range, consumers tend to have secure and well-paying jobs, and therefore they are more likely to make payments on time to avoid drawing negative credit ratings or incurring late fees. On the other hand, when inflation is too high, consumers may be more likely to lose their jobs, worry about their future economic conditions, and/or have to prioritize certain payment obligations over others, and therefore they are more likely to miss payments or default on a loan or a line of credit altogether.

Due to the impact of the macro environments (e.g., inflation as a macro-economic conditions indicator) on the behavioral characteristics of consumers, the riskiness of a loan or a line of credit for the consumers may vary and should not be evaluated in a vacuum, but rather should be evaluated by models that take into account of the macro environmental conditions. The present disclosure implements such a model that takes into the macro environmental conditions into consideration when evaluating the riskiness of offering a financial product, such as a loan or a line of credit, to users of an entity (e.g., a digital wallet provider).

For example, the present disclosure may access a plurality of data sources to obtain data pertaining to a creditworthiness of a user, and then use an underwriting model (e.g., a LightGBM model or another suitable type of machine learning model) to generate a riskiness score for that user. The riskiness score may be an indicator of how likely the user will miss payments or default on a loan or a line of credit over a given period of time. Such a score is then fed into a hyper model, along with macro environmental data, as inputs of the hyper model. In some embodiments, the macro environmental data may include indicators of macro-economic conditions, such as inflationary indicators. The hyper model utilizes a Naïve Bayes regression analysis to weigh a similarity measure between an observed negative outcome (e.g., the user missing payments or defaulting on the loan or line of credit) and the macro environmental data (e.g., the inflation indicator).

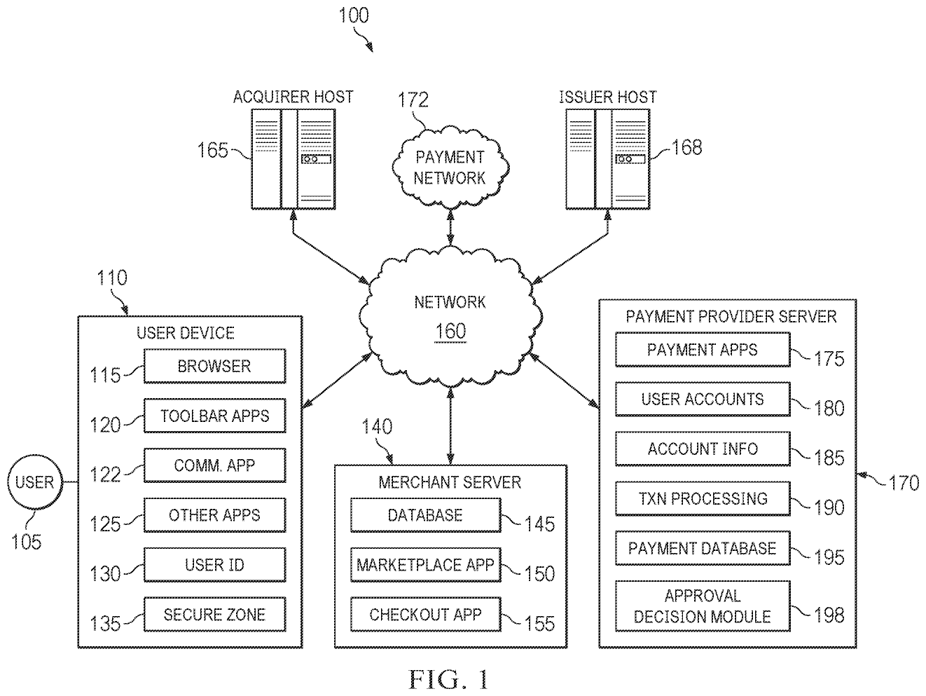

The hyper model then outputs a scaled riskiness score that may be either scaled up or down based on the macro environmental data. For example, the riskiness score may be scaled up based on relatively bad macro environmental data, which indicates that the user is more likely to miss or default on the payments. Alternatively, the riskiness score may be scaled down based on relatively good macro environmental data, which indicates that the user is less likely to miss or default on the payments. As a result, the hyper model of the present disclosure may be used to more accurately evaluate the riskiness of a loan/line of credit or other user behavioral characteristics that may be affected by macro environmental conditions. The various aspects of the present disclosure are discussed in more detail with reference to FIGS. 1-9.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a digital wallet provider (e.g., a payment service provider), such as PayPal™, Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

According to various aspects of the present disclosure, the merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online digital wallet provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, an approval decision module (ADM) 198 may also be implemented on the payment provider server 170 that provides predictions or outputs associated with offering or approving one or more financial products, such as a loan or credit line, to user 105, which can be through user device 110. The approval decision module 198 may include one or more software applications or software programs that can be automatically executed (e.g., without needing explicit instructions from a human user) to perform certain tasks. For example, the approval decision module 198 may utilize a machine learning model (e.g., a Light Gradient-Boosting Machine, or LightGBM) to generate an original underwriting model score based on a plurality of data sources (e.g., credit bureau data, data gathered and/or maintained by the digital wallet provider, and/or the customer profile of the user 105).

The approval decision module 198 may also maintain and/or operate a hyper model configured to scale the original underwriting model score. For example, the original underwriting model score, along with macro environmental data (e.g., inflationary indicator data), may be fed as inputs to a hyper model, which may generate the scaled underwriting model score at least in part based on the macro environmental data. In some embodiments, the hyper model utilizes a Naïve Bayes regression analysis to weigh a similarity measure between an observed negative outcome (e.g., the user missing payments or defaulting on the loan or line of credit) and the macro environmental data (e.g., the inflation indicator). Since the scaled underwriting model score takes the macro environmental conditions into account, the approval decision module 198 is able to evaluate user behavioral characteristic with more accuracy. For example, the approval decision module 198 can better predict whether a particular user will fall behind or default on a particular loan or line of credit in a given period of time. By doing so, the approval decision module 198 can help the digital wallet provider (and other suitable entities) make better decisions (e.g., whether to offer a loan or a line of credit to a user) without requiring additional electronic data. As such, electronic resources (e.g., computer processing power, electronic memory usage, network bandwidth) that would have been wasted on submitting, receiving, and/or processing the additional electronic data are now preserved. In this manner alone, the system 100 offers an improvement in computer technology.

It is noted that although the approval decision module 198 is illustrated as being separate from the transaction processing application 190 in the embodiment shown in FIG. 1, the transaction processing application 190 may implement some, or all, of the functionalities of the approval decision module 198 in other embodiments. In other words, the approval decision module 198 may be integrated within the transaction processing application 190 in some embodiments. In addition, it is understood that the approval decision module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the approval decision module 198 may include one or more sub-modules that are configured to perform specific tasks. For example, the approval decision module 198 may include a sub-module configured to generate the original underwriting model score and another sub-module configured to generate a revised (e.g., scaled up or down) underwriting model score.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

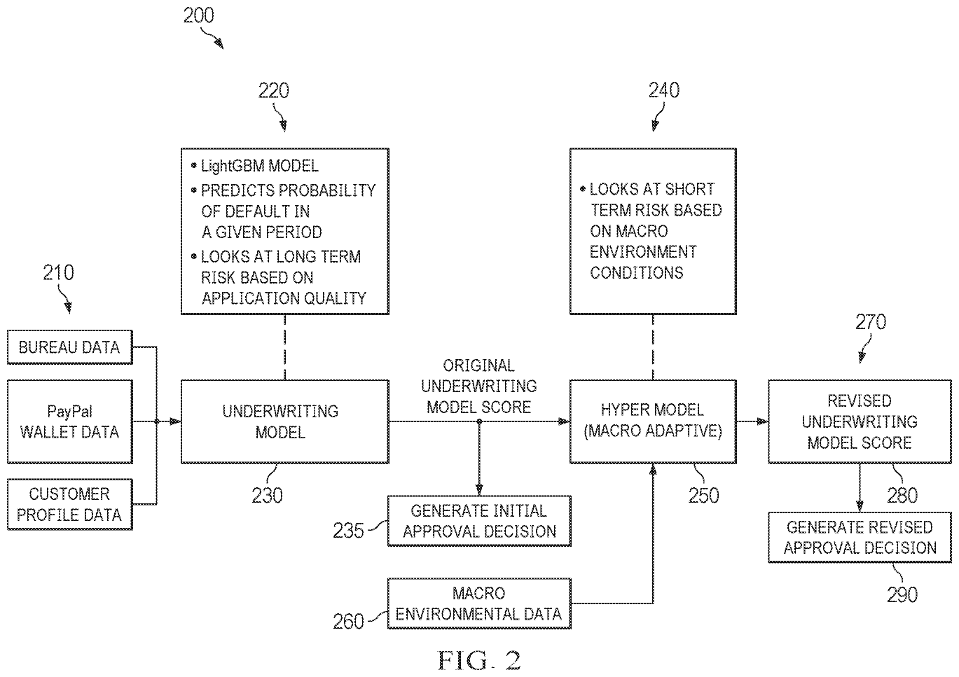

FIG. 2 illustrates a simplified block diagram corresponding to a process flow 200 in which the approval decision module 198 generates the revised underwriting model score according to embodiments of the present disclosure.

The process flow 200 starts at a step 210 by accessing data pertaining to users (e.g., the user 105 of FIG. 1 and other similar users) from a plurality of data sources. As non-limiting examples, FIG. 2 illustrates the data sources as “Bureau Data”, “PayPal Wallet Data”, and “Customer Profile Data.” In some embodiments, the “Bureau Data” may include data from a credit rating bureau or agency, such as a credit history or a credit score from EQUIFAX™ or TRANSUNION™. The “PayPal Wallet Data” may include historical user transaction data collected by PayPal™ (or another suitable digital wallet provider). The “Customer Profile Data” may include data corresponding to a user's customer profile, such as age, location, occupation, employment status, income, etc. In some embodiments, the data discussed above may be maintained in an electronic database. The data pertaining to users can be obtained from many more data sources and may vary between different users, such as based on financial product type being considered for offering, location, amount, type of user, and the like.

In a step 220 of the process flow 200, an original underwriting model score is generated based on the accessed data from step 210 via an underwriting model 230. The underwriting model 230 may train a machine learning model based on the data from step 210. In some embodiments, the machine learning model is a Light Gradient-Boosting Machine (LightGBM) model, though it is understood that other types of machine learning models may be used in other embodiments. The underwriting model 230 may produce an original underwriting model score, which may be a PUMA score in the embodiment illustrated in FIG. 2. The original underwriting model score may be used to predict a probability of a user default on financial products, such as a loan or a line of credit, in a given period (e.g., next 18 months). The original underwriting model score looks at a long-term risk of the loan or line of credit (generally referred to herein as including other types of financial products) based on an application quality, but it may not take into account of macro environmental conditions that are outside of the control of the users.

In a step 235 of the process flow, the original underwriting model score may be used to generate an initial approval decision. For example, when the original underwriting model score for a given user exceeds a specified threshold, an entity (e.g., the digital wallet provider) in charge of making the approval decision may decide to approve a loan or a line of credit for that given user. Conversely, when the original underwriting model score for the given user is below the specified threshold, the entity in charge of making the approval decision may decline or reject the loan or the line of credit for that given user.

In a step 240 of the process flow, a hyper model 250 is utilized to revise the original underwriting model score by taking macro environmental data 260 into account. As such, the hyper model 250 may also be referred to as a macro-adaptive model. For example, the macro environmental data 260 may be monitored (e.g., periodically at specified time intervals or on demand, such as when a financial products is being considered for an offering to a user or a group of users). When the monitored macro environmental data 260 indicates that the underlying macro environmental condition has exceeded a specified threshold (e.g., inflation becoming worse than a numeric threshold), then the hyper model 250 may be initialized and/or otherwise deployed. In other embodiments, however, the initialization and/or deployment of the hyper model 250 needs no trigger. In other words, the hyper model 250 may be automatically initialized and/or deployed regardless of the trend of the macro environmental data.

In some embodiments, the macro environmental data 260 may be a macro economic condition indicator, such as an inflationary indicator. For example, the inflationary indicator may comprise a Consumer Prices Index including owner occupiers' housing costs, also known as CPIH. As another example, the inflationary indicator may comprise a Producer Price Index (PPI). As yet a further example, the inflationary indicator may comprise a Personal Consumption Expenditures Price Index (PCE). The values of these indicators may be extracted from governmental entities such as the Bureau of Labor Statistics or the Bureau of Economic Analysis. Other indicators that are not directly related to inflation may also be used as a macro economic conditions indicator. For example, these other types of macro economic conditions indicator may include a Gross Domestic Product (GDP), a jobless number, an interest rate, a stock market index, a home sales number, a retail sales number, an industrial output, a price of a commodity. Non-economic indicators may also be used, such as indicators related to climate, demographics, geopolitics, ecology, legality, culture, society, etc. These non-economic indicators may be collected by governmental agencies, universities, non-profit research organizations, and/or other suitable institutions. In various embodiments, these additional types of macro environmental data could be used as a substitute for, or in conjunction with, the CPIH data discussed above, to generate a scaled score (which will be discussed below in more detail). In some embodiments, these additional types of macro environmental data may be used to perform additional iterative modifications to the score, and/or generate multiple scores. For example, one score may be generated using one type of macro environmental data, while another score may be generated using another type of macro environmental data. In some embodiments, an entity that is performing the score generation may be given an option to select the type(s) of macro environmental data to use to generate the score.

Regardless of what types of data is included in the macro environmental data 260, or how it is collected, it is understood that the macro environmental data 260, along with the original underwriting model score, may be fed as inputs to the hyper model 250. With these inputs, the hyper model 250 may utilize a Naïve Bayes regression analysis to weigh a similarity measure between an observed negative outcome (e.g., a user missing payments or defaulting on a loan or line of credit) and the macro environmental data 260 (e.g., an inflation indicator, such as CPIH).

In a step 270 of the process flow 200, the hyper model 250 outputs a revised underwriting model score 280. The revised underwriting model score 280 may be a scaled score based on the original underwriting model score. For example, in embodiments where the original underwriting model score is a riskiness score that indicates the probability of the user falling behind or defaulting on the payment of a loan or a line of credit, the revised underwriting model score may be the same type of score, but with a scaled-down value when the macro environmental data 260 is good (e.g., exceeding one or more indicators or thresholds), or with a scaled-up value when the macro environmental data 260 is bad (e.g., below one or more indicators or thresholds). This is because in good macro environmental conditions, the user is less likely to miss or default on payments, which should translate into a lower (e.g., scaled-down) riskiness score. Conversely, in bad macro environmental conditions, the user is more likely to miss or default on payments, which should translate into a greater (e.g., scaled-up) riskiness score.

In any case, the revised underwriting model score 280 can be used to evaluate user behavior (e.g., predicting the likelihood of the user missing payments or defaulting on the loan/line of credit) with greater accuracy than the original underwriting model score. For example, in a step 290 of the process flow, the revised underwriting model score 280 is used to generate the revised approval decision. Similar to the step 235, when the revised underwriting model score 280 for a given user exceeds a specified threshold, the entity in charge of making the approval decision may decide to approve the loan or the line of credit for that given user. Conversely, when the revised underwriting model score 280 for the given user is below the specified threshold, the entity in charge of making the approval decision may decline or reject the loan or the line of credit for that given user.

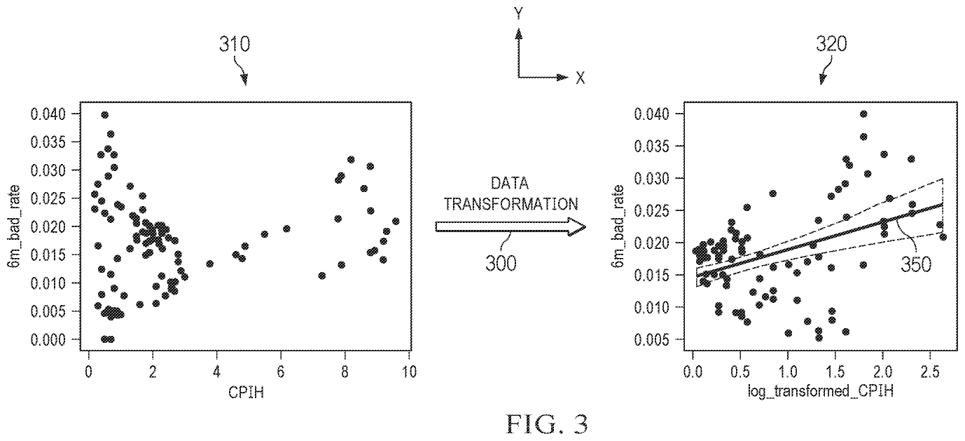

FIG. 3 illustrates a data normalization process 300 that is performed as a part of the construction of the hyper model 250 of FIG. 2 according to various aspects of the present disclosure. For example, FIG. 3 illustrates a graph 310 representing the initial data and a graph 320 representing the normalized data. The graph 310 and the graph 320 each include an X-axis (e.g., a horizontal axis) and a Y-axis (e.g., a vertical axis). The X-axis may represent a macro environmental criterion. In the embodiment illustrated in FIG. 3, the macro environmental criterion corresponds to CPIH, which as discussed above, is an inflation indicator that takes into account of owners' housing costs. The Y-axis represents a negative outcome of a loan or a line of credit. In the embodiment illustrated in FIG. 3, the negative outcome corresponds to a bad loan rate after 6 months (denoted as 6m_bad_rate in FIG. 3). As a non-limiting example, a bad loan may include a loan where the payor has missed a specified number of payments (e.g., two or more), or where the payor has defaulted altogether. It is understood that each of the dots in the graphs 310 and 320 corresponds to a specific rate of the negative outcome (e.g., a bad loan rate) at a specific macro environment (e.g., a CPIH rate). It is also understood that each of the dots may correspond to a single user in some embodiments, or it may correspond to a cluster of users or a user group in some other embodiments.

One reason for normalizing the data of the graph 310 is that the data in the graph 310 may be skewed around or near a certain region, for example, around the 3% region of the CPIH. This may make it more difficult to interpret the data and/or extract the underlying trends from it. As such, the present disclosure performs the data transformation process 300 to generate the graph 320, where it is easier to interpret the data and/or extract the underlying trends therefrom. According to various aspects of the present disclosure, a first step of the data transformation process 300 may involve normalizing the macro environmental criterion (e.g., CPIH in FIG. 3) by a predefined value. For example, the CPIH values of the graph 310 are normalized against a numeric value of 3 as the predefined value. In some embodiments, such a normalization may be performed by dividing each CPIH value by 3. Expressed mathematically, norm_CPIH=CPIH/3, where norm_CPIH represents the normalized macro environmental criterion, and CPIH represents the original (and un-normalized) CPIH values in the graph 320.

As a second step of the data transformation process 300, a log transform is performed to a subset of the normalized macro environmental criterion, where the values of the normalized macro environmental criterion in the subset are less than a predefined threshold. For example, the predefined threshold is 1, so that normalized CPIH values less than 1 are considered to be among the subset of the normalized macro environmental criterion. In this simplified example, the log transform is performed by applying a negative logarithm to the normalized CPIH values that are less than 1, but the normalized CPIH values that are greater than or equal to 1 are kept as is. Expressed mathematically:

Log_transformed_CPIH=−log(norm_CPIH), if norm_CPIH<1 1

Log_transformed_CPIH=norm_CPIH, if norm_CPIH>=1 2

The term log_transformed_CPIH represents the macro environmental criterion after the data transformation process 300 has been performed, and it is illustrated in FIG. 3 as the X-axis of the graph 320. The following computer code may be used to implement the data transformation process 300:
#normalise by 3
br_6m_df [′transformed_CPIH′]=br_6m_df [′CPIH′]/3
br_6m_df [‘log_transformed_CPIH’]=np.where (br_6m_df[′transformed_CPIH′]<1, −np.log (br_6m_df [′transformed_CPIH′]), br_6m_df [′transformed_CPIH′])

Note that the data transformation process 300 does not transform the values of the Y-axis of the graph 310 in this embodiment, but it is understood that the Y-axis values may be transformed in accordance with one or more algorithms in other embodiments.

As shown in the data-transformed graph 320, the dots may exhibit an identifiable trendline 350. The trendline 350 may have a linear characteristic, such that the Y-axis value rises as the X-axis value rises. This indicates that the negative outcomes (e.g., bad loan rates) tend to go up as the macro environmental criterion gets worse (e.g., inflation (measured by log_transformed_CPIH) rising). This insight-which is made available as a result of the data transformation process 300—is used in the construction of the hyper model 250 of FIG. 2, so that the hyper model 250 can accurately compensate or adjust the revised underwriting model score 280 that it outputs.

It is understood that this trendline 350 is based on a certain type of macro environmental criterion and a certain type of negative outcome, and it may not encompass the behavior of other types of macro environmental criteria and/or other types of negative outcomes. For example, in some cases, a trendline (e.g., corresponding to the trendline 350 of FIG. 3) may have a non-linear characteristic, such as a parabolic or hyperbolic characteristic. In other cases, the trendline may or may not have a linear characteristic, but it may have an optimized range.

For example, a rate of a negative outcome may be minimized when the macro environmental criterion is within a certain range (e.g., CPIH varying between 1% and 3%), but the rate of the negative outcome may rise when the macro environmental criterion is either less than the certain range (e.g., CPIH less than 1%) or greater than the certain range (e.g., CPIH greater than 3%). For reasons of simplicity, these other cases are not specifically illustrated herein.

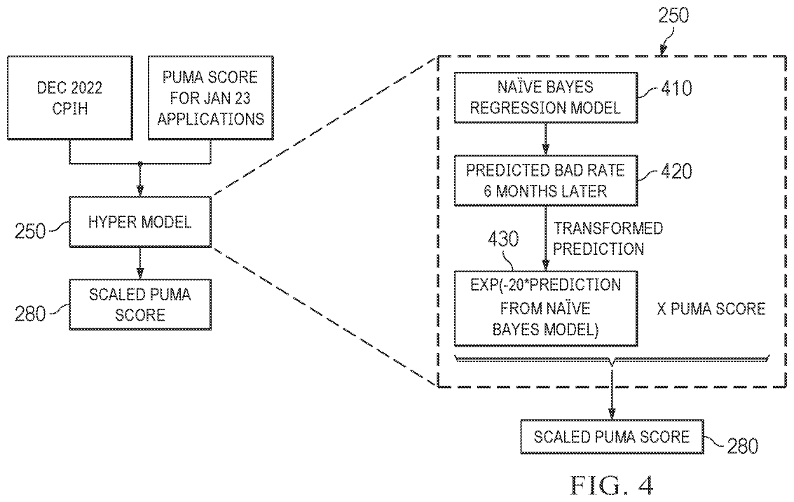

FIG. 4 illustrates a simplified block diagram corresponding to an embodiment of the hyper model 250 according to various aspects of the present disclosure. For example, the hyper model 250 receives, as its input, “December 2022 CPIH” (e.g., the CPIH number from December 2022 in a given country or geographical region, such as the U.K. or the U.S.A.) and “PUMA score for January 23 Applications” (e.g., the PUMA score for credit applications in January 2023). The December 2022 CPIH may be a non-limiting example of the macro environmental data 260 of FIG. 2, and the “PUMA score for January 23 Applications” may be a non-limiting example of the original underwriting model score generated by the underwriting model 230 of FIG. 2.

FIG. 4 also illustrates additional details of the hyper model 250 according to an embodiment of the present disclosure. For example, the hyper model 250 may include a Naïve Bayes regression model 410. The Naïve Bayes regression model 410 uses a similarity measure based on a Gaussian Kernel to weigh the observed negative outcomes (e.g., bad rate for a loan) and the macro environmental criteria (e.g., inflation as measured by CPIH). The Naïve Bayes regression model 410 then generates a block 420 as its predicted output, where the predicted output is based on a weighted mean of the negative outcomes. For example, in the embodiment of FIG. 4, the block 420 is a predicted bad rate (e.g., as an example negative outcome) 6 months later (but it could be for any other timeframe in alternative embodiments).

Thereafter, the predicted output undergoes a transformation in block 430. In the embodiment of FIG. 4, the transformation is mathematically expressed as exp (−20*prediction from the Naïve Bayes regression model), where exp represents an exponential function. The result from the block 430 may include a scaling factor (e.g., a numeric value), which is then multiplied by the “PUMA Score” (e.g., an example of the original underwriting model score, such as the “PUMA Score for January 23 Applications”) to generate the “Scaled PUMA Score” as an example of the revised underwriting model score 280 of FIG. 2. In some embodiments, the following computer programming code may be used to implement the Naïve Bayes regression model 410 and the blocks 420 and 430 (or portions thereof):

#naïve bayes class
import numpy as np
class NaiveBayesRegression:
   def train (self, X, y):
      self.mean=np.mean (y)
      self.inflation_mean=np.mean (X)
      self.inflation_std=np.std (X)
      self.inflation=X
      self.y=y
   def predict (self, X_test):
      predictions=[ ]
      for x in X_test:
         similarity=np.exp (−((x-self.inflation_mean)**2)/(2*self.inflation_std**2))
         weighted_mean=similarity*self.mean
         predictions.append (weighted_mean)
      return predictions
#Sample data
inflation=br_6m_df [‘log_transformed_CPIH’]
bad_rate=br_6m_df [‘6m_bad_rate’]
#Instantiate and train the NaiveBayesRegression model
nb_regression=NaiveBayesRegression ( )
nb_regression.train (inflation, bad_rate)
#Test data
inflation_test=np.array ([2.2, 3.8])
#Make predictions
predictions=nb_regression.predict (br_6m_df [‘log_transformed_CPIH’])
#Scale the Prediction
br_6m_df_scale [‘scale’]=np.exp (−20*br_6m_df_scale [‘prediction’])
#scale puma output
oot_s [‘prob_bag_tag_18_scaled’]=oot_s [‘prob_bag_tag_18’] *oot_s [‘scale’]

Note that although the present disclosure utilizes the Naïve Bayes regression to construct the hyper model 250, it is not intended to be limiting, and that other types of models (including other types of regression models) may also be used to construct the hyper model 250 in different embodiments.

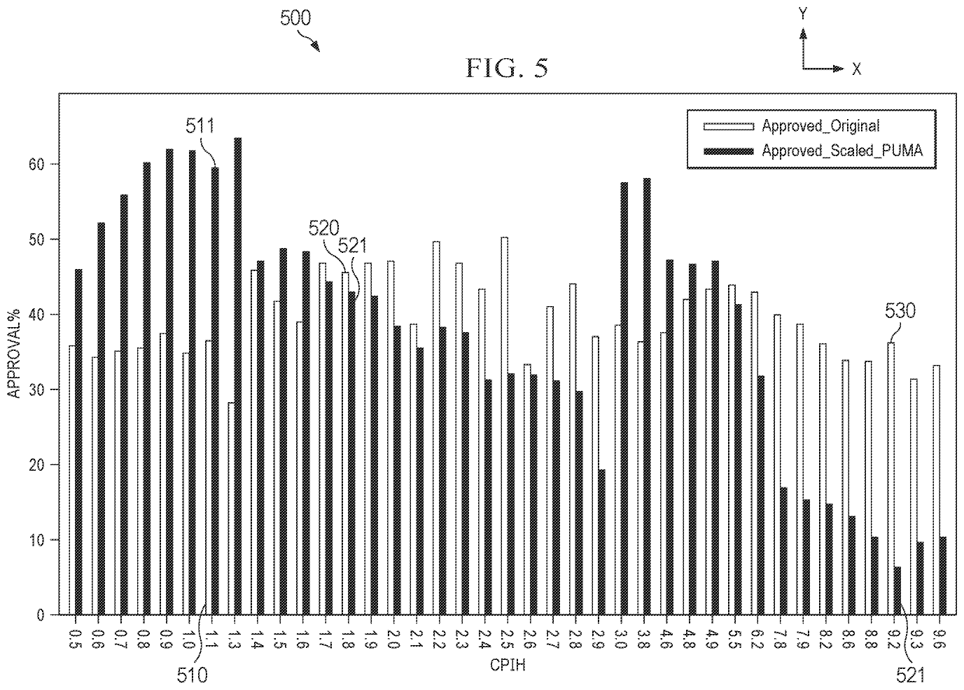

FIG. 5 is a graph 500 that illustrates how a loan/credit approval rate is affected by the scaling process discussed above according to an embodiment of the present disclosure. For example, the graph 500 includes an X-axis in the horizontal direction and a Y-axis in the vertical direction. The X-axis represents the macro environmental data (e.g., CPIH) in FIG. 5, but it is understood that the X-axis could represent any other type of macro environmental criterion, including but not limited to economic indicators such as inflationary indicators other than CPI or CPIH. The Y-axis represents a loan/credit approval rate in FIG. 5, but it is understood that the Y-axis could represent any other type of approval decision made with respect to a group of users/customers, including but not limited to applications for certain statuses or memberships.

The graph 500 includes a plurality of vertical bars that each represent the approval rate corresponding to a specific CPIH level. For the sake of facilitate the ensuing discussions, the vertical bars 510-511, 520-521, and 530-531 are labeled herein. The vertical bars 510, 520, and 530 represent the original loan/credit approval rates when the CPIH is at 1.1, when the CPIH is at 1.8, and when the CPIH is at 9.2, respectively. The vertical bars 511, 521, and 531 represent the scaled (e.g., revised) loan/credit approval rates when the CPIH is at 1.1, when the CPIH is at 1.8, and when the CPIH is at 9.2, respectively.

In more detail, when the CPIH is at 1.1, the original loan/credit approval rate is around 35% according to the vertical bar 510, but the scaled loan/credit approval rate is around 60% according to the vertical bar 511. The upscaling of the original loan/credit approval rate at this CPIH level is because 1.1 is a relatively low inflation level where even people with relatively bad credit are less likely to default or fall behind on loan payments. Accordingly, even potential borrowers who were previously marginal or barely missed the threshold for getting the approval may now be considered strong enough borrowers for whom the loan/credit application should be approved. Consequently, the approval rate is scaled up.

When the CPIH is at 1.8, the original loan/credit approval rate is around 46% according to the vertical bar 520, but the scaled loan/credit approval rate is around 44% according to the vertical bar 521. It can be seen that even though the loan/credit approval rate is technically downscaled, the amount of change is very little (˜2%). This is because 1.8 is a relatively standard inflation level where people behave at mostly a baseline level with respect to loan payments. Accordingly, not much scaling needs to be done for the approval rate in this case, and any amount of scaling tends to be small.

When the CPIH is at 9.2, the original loan/credit approval rate is around 35% according to the vertical bar 530, but the scaled loan/credit approval rate is around 6% according to the vertical bar 531. The downscaling of the original loan/credit approval rate at this CPIH level is significant because 9.2 is a somewhat high inflation level, where even people with relatively good credit are more likely to default or fall behind on loan payments. Accordingly, even potential borrowers who were previously above the threshold for getting the approval may now be considered weak enough borrowers for whom the loan/credit application should be declined. Consequently, the approval rate is scaled down. Based on the above discussions, it can be seen that the hyper modeling and the generation of the revised score can be used to effectively mitigate risk.

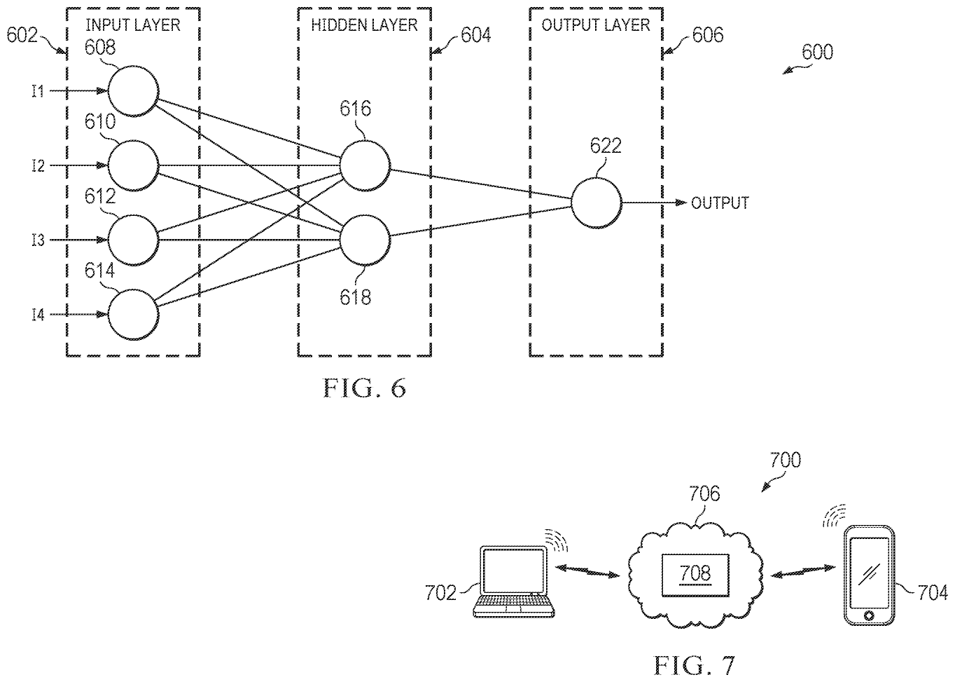

As discussed above, machine learning may be used to construct and/or implement the underwriting model 230 and/or the hyper model 250 of FIG. 2, or portions thereof. In some embodiments, the machine learning may be performed at least in part via an artificial neural network, which may be used to implement a machine learning module that can perform various machine learning processes. In that regard, FIG. 6 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the approval decision module 198, and the approval decision module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct attribute of a user or a macro environmental condition.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., a loan becoming bad due to missed payments or a loan default).

The artificial neural network 600 may be trained by using training data. For example, the training data herein may be the previous bad loans and their corresponding user data as well as the underlying macro environmental data associated with the bad loans. By providing training data to the artificial neural network 600, the nodes 616-618 in the hidden layer 604 may be trained (adjusted) such that an optimal output is produced in the output layer 606 based on the training data. By continuously providing different sets of training data, and penalizing the artificial neural network 600 when the output of the artificial neural network 600 is incorrect (e.g., when the determined (predicted) likelihood of a bad loan is inconsistent with whether the loan actually became bad, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm-which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the approval decision module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the various processes discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

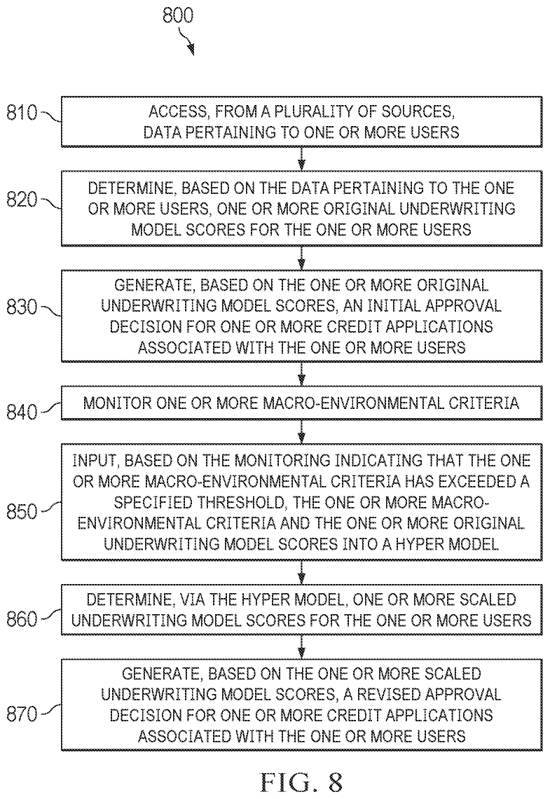

FIG. 8 is a flowchart illustrating a method 800 for generating an approval decision based on macro environmental conditions according to various aspects of the present disclosure. The various steps of the method 800, which are described in greater detail above, may be performed by one or more electronic processors, for example by the processors of a computer of an entity that may include (but are not limited to): a payment provider, a business analyst, or a merchant. The networked system described with respect to FIG. 1 is an example of a system that can perform the method 800. In some embodiments, at least some of the steps of the method 800 may be performed by the approval decision module 198 discussed above.

The method 800 includes a step 810 to access, from a plurality of sources, data pertaining to one or more users. In some embodiments, the data pertaining to the one or more users comprise credit bureau data, digital wallet data, or user profile data, as described with reference to step 210 of FIG. 2 above.

The method 800 includes a step 820 to determine, based on the data pertaining to the one or more users, one or more original underwriting model scores for the one or more users. In some embodiments, the step 820 may be performed at least in part by the underwriting model 230 of FIG. 2 discussed above. For example, the underwriting model 230 may include a Light Gradient-Boosting Machine (LightGBM) model, which may be used to calculate the one or more original underwriting model scores. The original underwriting model scores may comprise predictions of a default rate for the one or more users with respect to the one or more credit applications within a specified period of time. The credit applications may include an application for financial products, such as a loan or a line of credit, or for a predefined benefit, such as a status (e.g., a VIP status) or a membership to a club or an organization.

The method 800 includes a step 830 to generate, based on the one or more original underwriting model scores, an initial approval decision for one or more credit applications associated with the one or more users. The initial approval decision may be a decision to approve the one or more credit applications, or a decision to decline the one or more credit applications. The original underwriting model scores (e.g., generated by the underwriting model 230 of FIG. 2) may each include a numeric value that reflects the riskiness of the loan corresponding to the credit application.

The method 800 may include a step 840 to monitoring one or more macro environmental criteria. In some embodiments, the one or more macro environmental criteria comprise an inflationary measure criterion, such as CPIH. In other embodiments, the one or more macro environmental criteria may include other types of economic indicators, or even non-economic macro environment indicators, such as indicators related to climate, demographics, geopolitics, ecology, legality, culture, society, etc. The macro environmental criteria may be monitored on a periodic basis, such as monthly, weekly, or daily. The data corresponding to the macro environmental criteria may include the macro environmental data 260 of FIG. 2 discussed above.

The method 800 may include a step 850 to input, based on the monitoring indicating that the one or more macro environmental criteria has exceeded a specified threshold, the one or more macro environmental criteria and the one or more original underwriting model scores into a hyper model. The step 850 may correspond to the step 240 of FIG. 2 discussed above, where the original underwriting model score and the macro environmental data are both fed into the hyper model 250 as inputs. In some embodiments, the hyper model is configured to: scale up the one or more original underwriting model scores when the macro environmental criteria are within a specified range, and scale down the one or more original underwriting model scores when the macro environmental criteria deviates from the specified range.

In some embodiments, the hyper model is constructed at least in part by normalizing a macro environmental criterion of the one or more macro environmental criteria against a first predefined value. For example, the normalization process may include the data transformation process 300 discussed above with reference to FIG. 3. The construction of the hyper model may also include a log transform on the macro environmental criterion when the normalized macro environmental criterion is less than a second predefined value. For example, as discussed above with reference to FIG. 3, a log transform is performed to a subset of the normalized macro environmental criterion, where the values of the normalized macro environmental criterion in the subset are less than a predefined threshold. For example, the predefined threshold is 1, so that normalized CPIH values less than 1 are considered to be among the subset of the normalized macro environmental criterion. In this simplified example, the log transform is performed by applying a negative logarithm to the normalized CPIH values that are less than 1, but the normalized CPIH values that are greater than or equal to 1 are kept as is. In some embodiments, the hyper model is constructed at least in part using a Naïve Bayes regression model, such as the Naïve Bayes regression model 410 of FIG. 4. For example, the Naïve Bayes regression model is used to weigh a similarity measure between an observed negative outcome and the one or more macro environmental criteria.

The method 800 may include a step 860 to determine, via the hyper model, one or more scaled underwriting model scores for the one or more users. This step may correspond to the step 270 of FIG. 2, in which the revised underwriting model score 280 is generated. In some embodiments, the revised underwriting model score 280 may be a scaled score that reflects the riskiness of the credit application after taking into account of the macro environmental data. For example, the revised underwriting model score may be the same type of score as the original underwriting model score determined by step 820, but with a scaled-down value when the macro environmental data is “good,” or with a scaled-up value when the macro environmental data is “bad.”

The method 800 may include a step 870 to generating, based on the one or more scaled underwriting model scores, a revised approval decision for one or more credit applications associated with the one or more users. The step 870 may correspond to the step 290 of FIG. 2 discussed above. For example, when the revised underwriting model score (determined in step 860) for a given user exceeds a specified threshold, the entity in charge of making the approval decision may decide to approve the loan or the line of credit for that given user. Conversely, when the revised underwriting model score (determined in step 860) for the given user is below the specified threshold, the entity in charge of making the approval decision may decline or reject the loan or the line of credit for that given user. Note that although the approval decision is discussed using a credit application as an example, the same concepts may apply to approval decisions for other types of financial products and statuses or memberships as well.

It is understood that additional method steps may be performed before, during, or after the steps 810-870 discussed above. For example, the method 800 may include a step of constructing the original underwriting model, or revising the hyper model based on updated parameter. For reasons of simplicity, these additional steps are not discussed in detail herein.

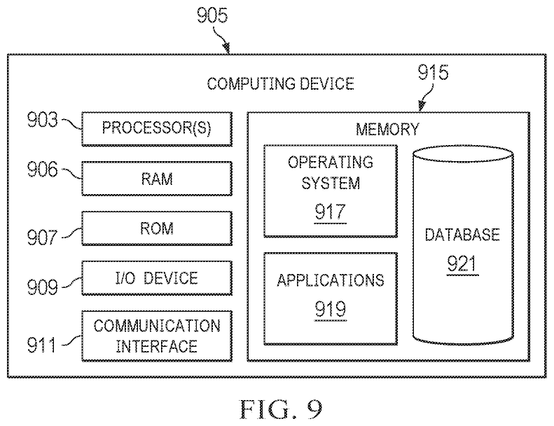

Turning now to FIG. 9, a computing device 905 that may be used with one or more of the computational systems is described. The computing device 905 may be used to implement various computing devices discussed above with reference to FIGS. 1-8. The computing device 905 may include a processor 903 for controlling overall operation of the computing device 905 and its associated components, including RAM 906, ROM 907, input/output device 909, communication interface 911, and/or memory 915. A data bus may interconnect processor(s) 903, RAM 906, ROM 907, memory 915, I/O device 909, and/or communication interface 911. In some embodiments, computing device 905 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 909 may include a microphone, keypad, touch screen, and/or stylus motion, gesture, through which a user of the computing device 905 may provide input, and may also include one or more speakers for providing audio output and a video display device for providing textual, audiovisual, and/or graphical output. Software may be stored within memory 915 to provide instructions to processor 903 allowing computing device 905 to perform various actions. For example, memory 915 may store software used by the computing device 905, such as an operating system 917, application programs 919, and/or an associated internal database 921. The various hardware memory units in memory 915 may include volatile and nonvolatile, removable and non-removable media implemented in any method or technology for storage of information such as computer-readable instructions, data structures, program modules, or other data. Memory 915 may include one or more physical persistent memory devices and/or one or more non-persistent memory devices. Memory 915 may include, but is not limited to, random access memory (RAM) 906, read only memory (ROM) 907, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 903.

Communication interface 911 may include one or more transceivers, digital signal processors, and/or additional circuitry and software for communicating via any network, wired or wireless, using any protocol as described herein.

Processor 903 may include a single central processing unit (CPU), which may be a single-core or multi-core processor, or may include multiple CPUs. Processor(s) 903 and associated components may allow the computing device 905 to execute a series of computer-readable instructions to perform some or all of the processes described herein. Although not shown in FIG. 9, various elements within memory 915 or other components in computing device 905, may include one or more caches, for example, CPU caches used by the processor 903, page caches used by the operating system 917, disk caches of a hard drive, and/or database caches used to cache content from database 921. For embodiments including a CPU cache, the CPU cache may be used by one or more processors 903 to reduce memory latency and access time. A processor 903 may retrieve data from or write data to the CPU cache rather than reading/writing to memory 915, which may improve the speed of these operations. In some examples, a database cache may be created in which certain data from a database 921 is cached in a separate smaller database in a memory separate from the database, such as in RAM 906 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 905 are described separately, functionality of the various components may be combined and/or performed by a single component and/or multiple computing devices in communication without departing from the invention.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: accessing, from a plurality of sources, data pertaining to one or more users; determining, based on the data pertaining to the one or more users, one or more original underwriting model scores for the one or more users; generating, based on the one or more original underwriting model scores, an initial approval decision for one or more credit applications associated with the one or more users; monitoring one or more macro environmental criteria; inputting, based on the monitoring indicating that the one or more macro environmental criteria has exceeded a specified threshold, the one or more macro environmental criteria and the one or more original underwriting model scores into a hyper model; determining, via the hyper model, one or more scaled underwriting model scores for the one or more users; and generating, based on the one or more scaled underwriting model scores, a revised approval decision for one or more credit applications associated with the one or more users.

Another aspect of the present disclosure involves a system that includes a non-transitory memory and one or more hardware processors coupled to the non-transitory memory and configured to read instructions from the non-transitory memory to cause the system to perform operations comprising: collecting data pertaining to one or more users, the collected data comprising credit bureau data, digital wallet data, or user profile data; calculating, based on the collected data and via an original underwriting model, one or more original underwriting model scores for a credit application associated with the one or more users; accessing macro environmental data; accessing a hyper model that is constructed at least in part via a Naïve Bayes regression model, wherein the hyper model is configured to: upwardly revise the one or more original underwriting model scores when the macro environmental data is within a specified range; and downwardly revised the one or more original underwriting model scores when the macro environmental data it outside the specified range; calculating, via the hyper model and the macro environmental data, one or more revised underwriting model scores; and generating, based on the one or more revised underwriting model scores, an approval decision for the credit application associated with the one or more users.

Yet another aspect of the present disclosure involves a non-transitory machine-readable medium having stored thereon machine-readable instructions executable to cause a machine to perform operations comprising: determining, via an original model, a first score for a user, wherein the first score indicates a risk for granting a predefined status to the user; generating, based on the first score, a decision with respect to granting the predefined status to the user; monitoring one or more macro environmental criteria; inputting the one or more macro environmental criteria and the first score into a hyper model; determining, via the hyper model, a second score for indicating a revised risk for granting the predefined status to the user, the revised risk taking into account of an impact of the one or more macro environmental criteria on the risk; and updating, based on the second score, the decision with respect to granting the predefined status to the user.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing, from a plurality of sources, data pertaining to one or more users;
determining, based on the data pertaining to the one or more users, one or more original underwriting model scores for the one or more users;
generating, based on the one or more original underwriting model scores, an initial approval decision for one or more credit applications associated with the one or more users;
determining one or more macro environmental criteria;
inputting, based on the one or more macro environmental criteria exceeding a specified threshold, the one or more macro environmental criteria and the one or more original underwriting model scores into a hyper model;
determining, via the hyper model, one or more scaled underwriting model scores for the one or more users; and
generating, based on the one or more scaled underwriting model scores, a revised approval decision for one or more credit applications associated with the one or more users;
wherein one or more of the accessing, the determining the one or more original underwriting model scores, the generating the initial approval decision, the determining the one or more macro environmental criteria, the inputting, the determining the one or more scaled underwriting model scores, or the generating the revised approval decision are performed by one or more electronic processors.

2. The method of claim 1, wherein the data pertaining to the one or more users comprise credit bureau data, digital wallet data, or user profile data.

3. The method of claim 1, wherein the one or more original underwriting model scores are determined via a Light Gradient-Boosting Machine (LightGBM) model.

4. The method of claim 3, wherein the one or more original underwriting model scores comprise predictions of a default rate for the one or more users with respect to the one or more credit applications within a specified period of time.

5. The method of claim 1, wherein the one or more macro environmental criteria comprise an inflationary measure criterion.

6. The method of claim 1, wherein the hyper model is configured to:
scale up the one or more original underwriting model scores when the macro environmental criteria are within a specified range; or
scale down the one or more original underwriting model scores when the macro environmental criteria deviates from the specified range.

7. The method of claim 1, further comprising constructing the hyper model at least in part by normalizing a macro environmental criterion of the one or more macro environmental criteria against a first predefined value.

8. The method of claim 7, wherein the hyper model is further constructed at least in part by performing a log transform on the macro environmental criterion when the normalized macro environmental criterion is less than a second predefined value.

9. The method of claim 1, further comprising constructing the hyper model at least in part via a Naïve Bayes regression model.

10. The method of claim 9, further comprising: weighing, via the Naïve Bayes regression model, a similarity measure between an observed negative outcome and the one or more macro environmental criteria.

11. The method of claim 1, wherein the generating the initial approval decision or the generating the revised approval decision comprises declining the one or more credit applications.

12. A system comprising:
a processor; and
a non-transitory computer-readable medium having stored thereon instructions that are executable by the processor to cause the system to perform operations comprising:
collecting data pertaining to one or more users, the collected data comprising credit bureau data, digital wallet data, or user profile data;
calculating, based on the collected data and via an original underwriting model, one or more original underwriting model scores for a credit application associated with the one or more users;
accessing macro environmental data;
accessing a hyper model that is constructed at least in part via a Naïve Bayes regression model, wherein the hyper model is configured to:
upwardly revise the one or more original underwriting model scores when the macro environmental data is within a specified range; or
downwardly revised the one or more original underwriting model scores when the macro environmental data it outside the specified range;
calculating, via the hyper model and the macro environmental data,
one or more revised underwriting model scores; and
generating, based on the one or more revised underwriting model scores, an approval decision for the credit application associated with the one or more users.

13. The system of claim 12, wherein the original underwriting model comprises a Light Gradient-Boosting Machine (LightGBM) model, and wherein the one or more original underwriting model scores comprise predictions of a negative outcome with respect to the credit application within a specified period of time.

14. The system of claim 12, wherein the macro environmental data comprise an economic indicator.

15. The system of claim 12, wherein the operations further comprise constructing the hyper model at least in part by normalizing the macro environmental data against a first predefined value.

16. The system of claim 15, wherein the hyper model is further constructed at least in part by performing a log transform on the macro environmental data when the normalized macro environmental data is less than a second predefined value.

17. The system of claim 12, wherein the operations further comprise: weighing, via the Naïve Bayes regression model, a similarity measure between an observed negative outcome and the macro environmental data.

18. A non-transitory machine-readable medium having stored thereon machine-readable instructions executable to cause a machine to perform operations comprising:
determining, via an original model, a first score for a user, wherein the first score indicates a risk for granting a predefined benefit to the user;
generating, based on the first score, a decision with respect to granting the predefined benefit to the user;
monitoring one or more macro environmental criteria;
inputting the one or more macro environmental criteria and the first score into a hyper model;
determining, via the hyper model, a second score for indicating a revised risk for granting the predefined benefit to the user, the revised risk taking into account of an impact of the one or more macro environmental criteria on the risk; and
updating, based on the second score, the decision with respect to granting the predefined benefit to the user.

19. The non-transitory machine-readable medium of claim 18, wherein:
the original model is constructed at least in part using a Light Gradient-Boosting Machine (LightGBM) model; and
the hyper model is constructed at least in part via a Naïve Bayes regression model.

20. The non-transitory machine-readable medium of claim 18, wherein the operations further comprise constructing the hyper model at least in part by:
normalizing the macro environmental criteria against a first predefined value; and
performing a log transform on the macro environmental criteria when the normalized macro environmental criteria is less than a second predefined value.
